(19) United States
(12) Patent Application Publication
(10) Pub. No.: US 2008/0020693 A1
(43) Pub. Date: Jan. 24, 2008

(54) METHOD OF DEBONING ANIMAL MEAT BLOCK AND DEBONING APPARATUS

(75) Inventors: Katsumi Toyoshima, Saku-city (JP); Toshihide Takahashi, Saku-city (JP)

Correspondence Address: ROSSI, KIMMS & McDOWELL LLP., P.O. BOX 826, ASHBURN, VA, 20146-0826, US

(73) Assignee: MAYEKAWA MFG. CO., LTD., Tokyo (JP)

(21) Appl. No.: 11/782,753

(22) Filed: Jul. 25, 2007

Related U.S. Application Data
(63) Continuation of application No. PCT/JP05/01300, filed on Jan. 25, 2005.

(51) Int. Cl. A22C 17/00; A22C 17/02

(52) U.S. Cl. 452/135

(57) ABSTRACT

A deboning method and a deboning apparatus is provided whereby a meat block at the humerus part having a part of the scapula remaining therein, which corresponds to the shoulder part of a back split block of an animal meat (for example, beef, pork, horse meat, goat meat or poultry meat), can be completely automatically deboned after a simple pretreatment by human hand.

### CROSS-REFERENCE TO RELATED APPLICATIONS

This is a continuation of International Application PCT/JP2005/001300 (published as WO2006/080085 A1) having an international filing date of 25 Jan. 2005, the contents of which is incorporated by reference herein.

### BACKGROUND

The present invention relates to a deboning method and a deboning apparatus in which a meat block (hereinafter referred to as the “work”) including a humerus part and a part of a scapula at a shoulder part 70 of a halved block of back split meat such as beef, pork, horse meat, sheep meat, goat meat or poultry meat can be completely automatically deboned after a simple pretreatment by human hand as seen from a diagram of cuts of the pork in FIG. 18. The present invention more particularly relates to a deboning method and a deboning apparatus in which, after removing a remaining part of a forearm bone left at a time when a joint portion between the forearm bone and a humerus is cut and exposing the joint portion of the humerus as a pretreatment by human, such a work conveyed with a loader is deboned and in which middle steps of cutting muscle of meat, measuring a length of the humerus and peeling off a meat part can mechanically be performed, whereby a deboning treatment is completely automated to reduce a treatment time and improve a treatment efficiency.

Heretofore, to debone back split meat blocks, in a meat treatment place for these back split meat blocks, beef or pork is largely divided into five parts including shoulder, loin, belly, thigh and fillet.

Among these parts, an apparatus which debones a shoulder part is disclosed in, for example, WO2004/068953 A1 (Prior Art 1).

This deboning apparatus has a purpose of realizing a meat deboning apparatus for medium and small treatment plants in which a space is saved and a cost is reduced. This apparatus is a deboning apparatus for an arm/shoulder loin part 70 shown in FIG. 18 of a cut block of meat such as pork, beef, horse meat, sheep meat, goat meat or the like subjected to a pretreatment by hand including back splitting and largely dividing of the meat. The apparatus is more particularly a small-sized meat deboning apparatus in which as the pretreatment, the meat is divided to remove a shoulder loin part and a spare rib, a forearm bone is removed, and muscle around a humerus and a scapula is then cut. The cut meat subjected to the maximum pretreatment is subjected to a minimum necessary deboning treatment. The scapula is peeled off (the scapula is removed) and the humerus is automatically removed to separate the meat.

In this deboning apparatus, as shown in FIG. 19, on a downstream side of an introducing station 010, a scapula deboning station 011 in which a scapula is peeled off is disposed with a predetermined space S from the introducing station 010, and a humerus deboning station 012 in which a humerus is removed is similarly disposed with a space S equal to the above predetermined space. On a downstream side of the humerus deboning station 012, a bone part discharge station 013 in which a bone part of the humerus remaining after meat separation at the above station is discharged is disposed. The stations are disposed in order and constitute a deboning line having ends.

In the introducing station 010, at a gap of a fixed conveyance path 014a including two extending rails which form a conveyance path and between which the space S is disposed, a constricted part of the humerus of a work 050 is inserted and hung. The work includes an arm part of back split meat which has been roughly divided into five parts and from which a shoulder loin part and a forearm bone have been removed. In consequence, an introduction step 022 is performed.

Subsequently, in the next first conveyance step 023, a pushing section 019 is operated to introduce the work 050 subjected to the introduction step into a movable conveyance path 015a of the adjacent scapula deboning station 011 via tact conveyance (a mechanism in which a pressurizing cylinder is operated to pressurize and advance the work as much as a unit station corresponding to one stroke of the pressurizing cylinder), and the work is held at the station 011. When the work is held, the pushing section 019 leaves the work 050 at an original position of the movable conveyance path 015a, and returns to an original position of the introducing station 010.

Subsequently, in the next scapula deboning step 024, the movable conveyance path 015a of the station 011 where the work 050 introduced in the previous step is held is detached from the original position to move up to a deboning treatment position, where a scapula 052 is peeled off and removed, thereby ending the deboning treatment. The movable conveyance path 015a holds a work 051 and returns to the original position.

Subsequently, in the next second conveyance step 025, the work 051 subjected to the above deboning step is introduced into a movable conveyance path 017a of the adjacent humerus deboning station 012 via a pushing section 020 of the tact conveyance, and held at the station 012. When the work 051 is held, the pushing section 020 leaves the work 051 at an original position of the movable conveyance path 017a, and returns to an original position of the scapula deboning station 011.

Subsequently, in the next humerus deboning step 026, the movable conveyance path 017a of the humerus deboning station 012 where the work 051 introduced in the previous step is held is detached from the original position to move up to the deboning treatment position where the humerus is removed and meat 053 is peeled off, thereby ending the deboning treatment. The movable conveyance path 017a holds a humerus 054 and returns to the original position.

Subsequently, in the next conveyed bone part discharge step 027, a humerus 054 subjected to the above deboning step is conveyed and discharged to the adjacent bone part discharge station 013 via a pushing section 021 of the tact conveyance. When the humerus is discharged, the pushing section 021 returns to the original position of the humerus deboning station.

Through the above-mentioned introduction→first conveyance→scapula deboning→second conveyance→conveyed bone part discharge steps, the deboning treatment of the work ends.

It is to be noted that the introduction is performed immediately after the pushing sections 019, 020 and 021 linearly and integrally connected via a coupling pestle simultaneously return to their original positions as old positions by a returning operation of an actuator described later immediately after the subsequent-stage first conveyance, second conveyance and conveyed bone part discharge steps. The stations are replenished with the following works, and the deboning can continuously be performed.

Moreover, in Japanese Patent Application Laid-Open No. 2004-236577 (Prior Art 2), with respect to a work to be subjected to deboning in a state in which a half block of back split meat is hung, as a deboning apparatus which can cope with either a left block or a right block at random, a meat deboning method and a meat deboning apparatus are disclosed in which it is judged that the block is the left block or the right block. According to the judgment result, a portion to be switched at a left or right switching station is switched to the left or the right to form a left or right random deboning treatment line, and the left and right lines can selectively be used to effectively perform the deboning treatment. Moreover, the work can be introduced with an automatic loading device, the bone part can securely be held during the deboning, and a bone joint can be prevented from being dislocated.

As shown in FIG. 20, this apparatus includes a pretreatment section 030 which cuts muscle of a work including a back split meat block to be deboned in a hung state; a work introducing section 031 which introduces the pretreated work into a deboning treatment line formed by the meat deboning apparatus of the invention via the automatic loading device; a left or right judgment section 032 which judges whether the introduced work suspended from a clamper corresponds to the left block or the right block; a left or right switch operating section 033 which outputs a left or right switch signal to the corresponding station on a downstream side according to the judgment result of the judgment section; a left or right switch station 034 which receives the left or right switch signal to switch a portion required to be switched; a tact feed section 035 which performs the switching to form a left or right random deboning line; and a deboning discharge section 036.

Moreover, the following operation is performed according to the judgment result of the left or right judgment section 032.

The left or right judgment section 032 judges that the introduced meat block corresponds to the left block or the right block. In response to a judgment signal, the left or right switch operating section 033 allows the corresponding left or right switch station 034 to switch a treatment position to the left or the right and to select a left treatment jig or a right treatment jig. In cooperation with the tact conveyance of the tact feed section 035, the left or right random deboning line is formed.

The meat blocks including an inner shoulder part and a leg part are sorted as the right and left blocks at the subsequent-stage deboning line, and branched to right and left deboning lines for exclusive use, and the deboning is substantially automatically performed at the deboning lines for exclusive use, respectively.

According to the above-mentioned constitution, it is judged that the meat block is either the left or right block, and the left or right random deboning line is used in accordance with the judgment. In consequence, unlike the conventional right and left deboning lines for exclusive use, equipment costs can be reduced, an operation ratio can be improved, and the operation can efficiently be performed. Since an idling time of an equipment is reduced owing to the improvement of the operation ratio, a facility can securely hygienically be controlled, and deboning and scrapping can be performed under a more preferable hygienic environment.

However, the shoulder part of the work to which each prior art described above is applied is a shoulder part including a forearm bone, a humerus and a scapula as shown in FIGS. 5 and 6 of Prior Art 2, or a shoulder part including at least the humerus and the scapula as shown in FIG. 19 which is an accompanying drawing of Prior Art 1. On the other hand, as shown in FIG. 21, an upper part of a shoulder part is cut along a portion (a cutting line x) which is easily cut along lumbar vertebras. In consequence, a part of the scapula is left. A lower part of the shoulder part is cut along a joint part (a cutting line y) between a forearm bone and a humerus.

FIG. 21 shows a framework of a slaughtered pig. In FIG. 21, reference numerals 040 are lumbar vertebras (seven vertebras), 041 are thorn projections, 042 is a thighbone, 043 are ribs, 044 is a scapula, 045 is a forearm bone and 046 is a humerus.

Especially, in the North America, as described above, the pork is cut along the cutting lines x and y, and the part of the remaining forearm bone 045 is sold as bone meat including the bone attached as it is.

The shoulder part cut at such a cutting position has a problem that the part cannot be subjected to the deboning treatment with the deboning apparatus described in the above prior art.

Moreover, in the device of Prior Art 1, as shown in FIG. 19, the work is temporarily stopped in the deboning step of the scapula and the deboning step of the humerus. Subsequently, the work is temporarily removed from a conveyance path, and moved up to the deboning treatment position where the scapula or the humerus is removed and the meat is peeled off. After ending such a deboning treatment, a step of returning the work to the conveyance path is performed. Therefore, there is a problem that it takes much time to perform the deboning treatment.

### SUMMARY OF THE INVENTION

The present invention has been developed in view of such a conventional technical problem, and an object thereof is to realize a deboning method and a deboning apparatus for carrying out the deboning method in which a deboning treatment can be applied to a shoulder part including a part of a scapula left at a time when an upper part is cut along a portion easily cuttable along lumbar vertebras and including a lower part cut at a joint portion between a forearm bone and a humerus.

Moreover, a second object of the present invention is to realize a deboning method and a deboning apparatus in which, to debone the shoulder part, the shoulder part hung with a clamping device is conveyed and subjected to a deboning treatment without discontinuing the conveyance, whereby a treatment time can be reduced and a treatment efficiency can be improved.

The present invention achieves such objects. A first aspect of the invention relates to a method of deboning a meat block which is cut along a joint part between a forearm bone and a humerus and at an upper part of a scapula, including the humerus and a part of the scapula while hanging and conveying the meat block with a loader, the method comprising: a first step of perpendicularly cutting the meat block to expose bone parts; a second step of peeling off the meat from an upper part of the humerus to a part of the humerus below the center thereof with a meat separator and horizontally cutting muscle of the center of the humerus; a third step of further peeling off the meat down to a joint part between the humerus and the scapula with a meat separator and measuring a length from a reference position positioned at the upper part of the humerus to the joint part between the humerus and the scapula to determine a lowering position of the meat separator in the subsequent step based on a value of the length thus measured; a fourth step of peeling off, in a stepwise manner, the meat around the joint part with a meat separator while cutting the muscle around the joint part between the humerus and the scapula; and a fifth step of cutting muscle around the scapula and peeling off the meat around the scapula with a meat separator.

In the first invention, as described above, the meat block cut along the joint part between the forearm bone and the humerus and at the upper part of the scapula and including the humerus and a part of the scapula is regarded as a target of the deboning (such a work of a part constituting the deboning target of the present invention will hereinafter be referred to as the “target work”). Preferably, in a pretreatment, a remaining part of the forearm bone is removed to expose a bone of the joint part of the humerus, and the work hung and conveyed with the loader is subjected to the deboning treatment.

In the first step, the target work is perpendicularly cut to expose the bone part. As means for performing this step, for example, a round blade cutter or the like perpendicularly arranged so as to come close to or away from the target work along a conveyance path may be used.

Subsequently, as the second step, the meat is peeled off from the upper part of the humerus to the part of the humerus below the center thereof by use of the meat separator. Moreover, the muscle of the center of the humerus is horizontally cut, for example, with the horizontally arranged round blade cutter or the like. When this muscle is cut, the meat which covers the humerus can further be peeled off close to the joint part between the humerus and the scapula.

Subsequently, as the third step, while the meat is further peeled off down to the joint part between the humerus and the scapula with the meat separator, the length from the reference position positioned at the upper part of the humerus to the joint part between the humerus and the scapula is measured to determine a lowering stroke of the meat separator in the subsequent step, that is, during the peeling of the meat around the joint part between the humerus and the scapula and around the scapula, based on the value of the length thus measured. In this case, preferably, when a clamping position where the target work is clamped with the loader is regarded as the reference position, the reference position is clarified, and the measurement to the joint part between the humerus and the scapula is facilitated. When the clamping position is a constricted part of the joint part between the forearm bone and the humerus, the work is easily clamped. More preferably, when a length from the reference position to an upper surface of a projection of the joint part between the humerus and the scapula is measured, a measurement point is clarified.

Subsequently, the muscle around the joint part is peeled off in the stepwise manner with the meat separator while cutting the meat around the joint part between the humerus and the scapula (the fourth step). Furthermore, the muscle around the scapula is cut, and the meat around the scapula is peeled off with the meat separator (the fifth step).

According to the first invention, the slight pretreatment by hand is involved, but the substantially completely automated deboning treatment of the target work can be realized. In consequence, reduction of a treatment time and improvement of a treatment efficiency can be achieved.

Moreover, the treatment step is finely divided into the first to fifth steps. In a stage of each treatment step, while cutting the muscle bonded to the bone, the meat is finely peeled off in the stepwise manner. In consequence, the humerus of the target work does not have to be separated from the scapula, and the bones can completely be separated without leaving any extra meat at the bone.

A second aspect of the present invention is related to the apparatus to carry out the deboning method according to the first invention, in which a meat block cut along a joint part between a forearm bone and a humerus and at an upper part of a scapula and including the humerus and a part of the scapula is subjected to a deboning treatment while hung and conveyed with a loader, wherein the loader is configured to pass through a plurality of stations and perform the deboning treatment while the loader hangs the meat block to convey the meat block in a horizontal direction, at least a part of the stations includes a round blade cutter to cut muscle arranged along a conveyance path of the meat block, a meat separator which separates meat of the meat block from a bone, and a measurement device which measures a length from a reference position positioned at an upper part of the humerus to a joint part between the humerus and the scapula, and a lowering stroke from an original height (a height before lowering) of the meat separator arranged at each of the stations is determined based on the measured value.

In the second invention, the loader is constituted so as to pass through the plurality of stations to perform the deboning treatment while the loader conveys the hung meat block in the horizontal direction. Along this conveyance path, the meat separator and the round blade cutter for cutting the muscle are disposed for each step, the muscle which covers the bone is cut, and the meat is peeled off. The length from the reference position positioned at the upper part of the humerus to the joint part between the humerus and the scapula after the meat is peeled off is measured with the measurement device, and the lowering stroke from the original height of the meat separator is determined based on this measured value.

According to the second invention, a slight pretreatment by hand is involved, but a substantially completely automated deboning treatment of a target work can be realized. In consequence, reduction of a treatment time and improvement of a treatment efficiency can be achieved.

Moreover, in each stage of a treatment step, while muscle bonded to the bone is cut by the round blade cutter for cutting the muscle, the meat is peeled off in a stepwise manner by the meat separator. In consequence, the humerus of the target work does not have to be separated from the scapula, and the meat can finely be separated. The meat can completely be separated without leaving any extra meat at the bone.

Furthermore, halfway in the treatment step, the reference position is set to the upper part of the humerus, the length from this reference position to the joint part between the humerus and the scapula is measured, and a lowering stroke of the meat separator is set based on the measured value at each station. Therefore, even if an arm part of a treatment target has different length and size, a cutting position of the round blade cutter, a reference height and the lowering stroke of the meat separator can be changed so as to cope with the difference according to circumstances.

In this second invention, preferably the meat separator has two separation surfaces which face each other along the conveyance path of the meat block, and includes a driving device which vertically moves the separation surfaces. In consequence, a meat content of the target work can be peeled off in a state in which the target work is nipped between the separation surfaces, and the meat separator having a simple structure and a satisfactory separation performance can be constituted. In addition, when a conveyance speed of the target work and a lowering speed of the separation surfaces are regulated, a speed at which the meat content is peeled off can freely be regulated.

More preferably, the plurality of stations are substantially installed at an equal height level, and the loader hangs and conveys the meat block at a substantially constant height over all deboning steps. According to this constitution, a speed of the treatment can further be increased, the reduction of the treatment time and the improvement of the treatment efficiency can further be achieved, and an apparatus constitution can be simplified.

### BRIEF DESCRIPTION OF THE DRAWINGS

The invention will be described in detail with reference with reference to the following figures, wherein:

FIG. 1 is the whole constitution diagram of a first embodiment of a deboning apparatus according to the present invention, (a) is a plan view, (b) is an elevational view, (c) is a sectional view cut along the C-C line of (b), and (d) is a right side view;

FIG. 2 shows a target work (an arm part) regarded as a deboning target of the present invention, (a) is a plan view showing a state before a pretreatment by hand, (b) is an elevational view of the state, (c) is a plan view showing a state after the pretreatment by hand, and (d) is an elevational view of the state;

FIG. 3 is a step diagram showing each deboning step according to the first embodiment;

FIG. 4 is a perspective view of a device for use in a second station of the first embodiment;

FIG. 5 is a perspective view of a meat separator 20 for use in the first embodiment as obliquely viewed from above;

FIG. 6 is a perspective view of the meat separator 20 obliquely viewed from below;

FIG. 7 is a perspective view of a device for use at a third station of the first embodiment as viewed from an upstream side in a conveyance direction of a target work;

FIG. 8 is a perspective view of the device of FIG. 7 as viewed from a downstream side in the conveyance direction of the target work;

FIG. 9 is an elevational view of the device of FIG. 7 as viewed from the upstream side in the conveyance direction of the target work;

FIG. 10 is a back view of the device of FIG. 7 as viewed from the downstream side in the conveyance direction of the target work;

FIG. 11 is a perspective view of a device for use in a fourth station of the first embodiment as viewed from above on the left side;

FIG. 12 is a perspective view of the device of FIG. 11 as viewed from above on the right side;

FIG. 13 is a perspective view of a device for use in a fifth station of the first embodiment as viewed from above on the left side;

FIG. 14 is a perspective view of the device of FIG. 13 as viewed from above on the right side;

FIG. 15 is a perspective view of a device for use in a sixth station of the first embodiment;

FIG. 16 is a perspective view of a device for use in a seventh station of the first embodiment;

FIG. 17 is a perspective view of the device of FIG. 16 as viewed from below;

FIG. 18 is a diagram of cuts of pork;

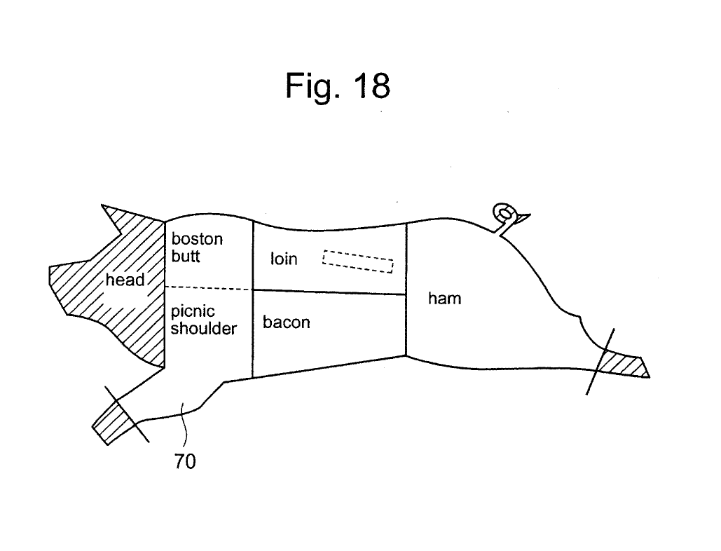

FIG. 19 is a step diagram showing one example (Prior Art 1) of a conventional apparatus which debones a shoulder part;

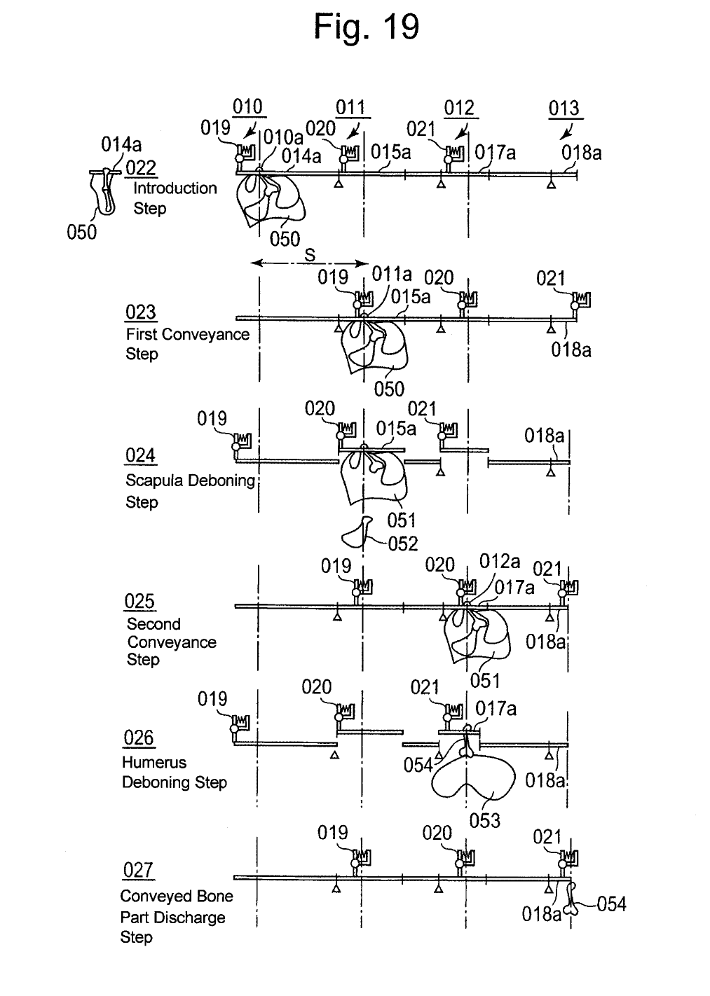

FIG. 20 is a step diagram showing one example (Prior Art 2) of a conventional method of deboning a meat block; and

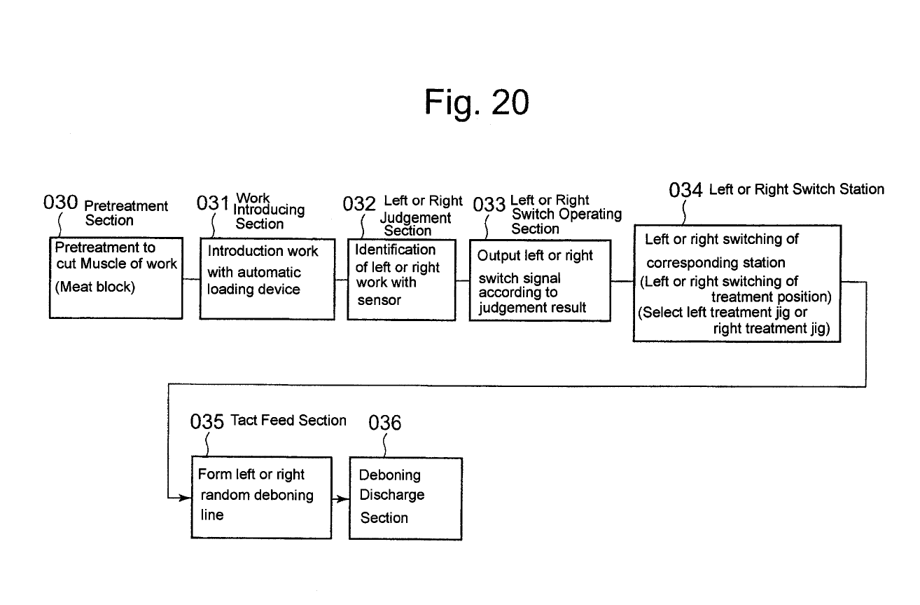

FIG. 21 is a diagram showing a framework of a slaughtered pig.

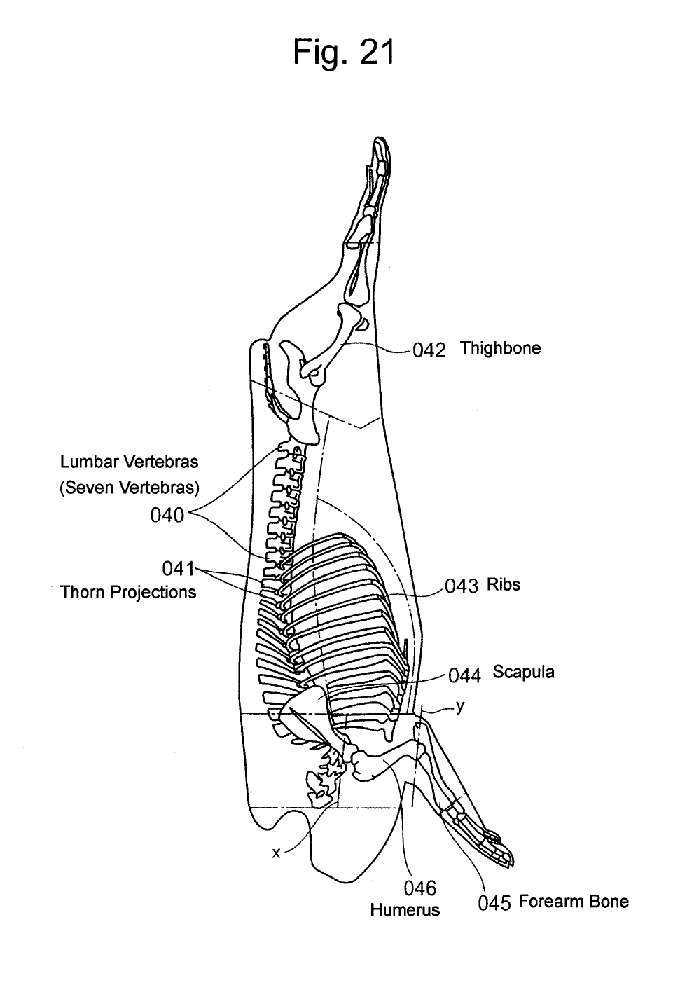

### DETAILED DESCRIPTION OF THE PREFERRED EMBODIMENTS

The present invention will hereinafter be described in accordance with an embodiment in detail with reference to the drawings. Dimensions, materials, shapes, relative arrangements and the like of constituting components described in this embodiment do not limit the scope of this invention, and are merely illustrated examples, unless specifically described.

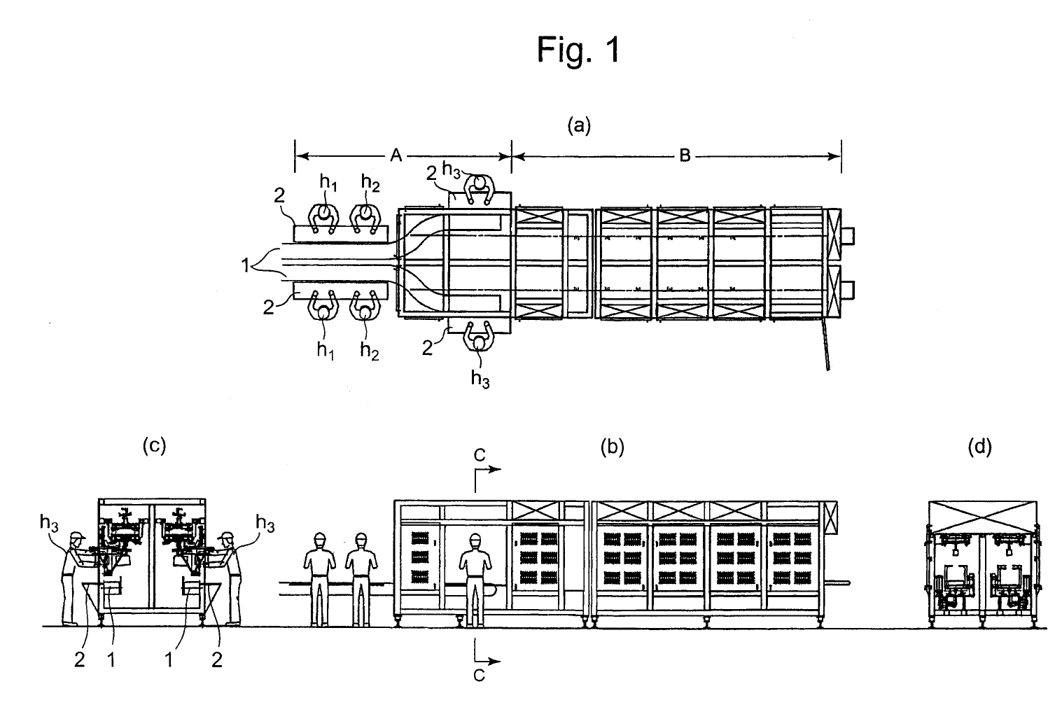

In the whole constitution diagram of FIG. 1 according to a first embodiment of the present invention, an apparatus of the present embodiment has two lines of left and right, A is a region where a pretreatment is performed by hand, and B is a deboning treatment region by the apparatus of the present embodiment. Reference numeral 1 is a conveyer on which a target work is mounted and carried, and 2 is a cutting board on which operators h1 to h3 perform the pretreatment. In the present apparatus, after the operators perform the pretreatment in the region A, the workers h3 hang the target work from a clamping unit of a loader to convey the work to a mechanical treatment region.

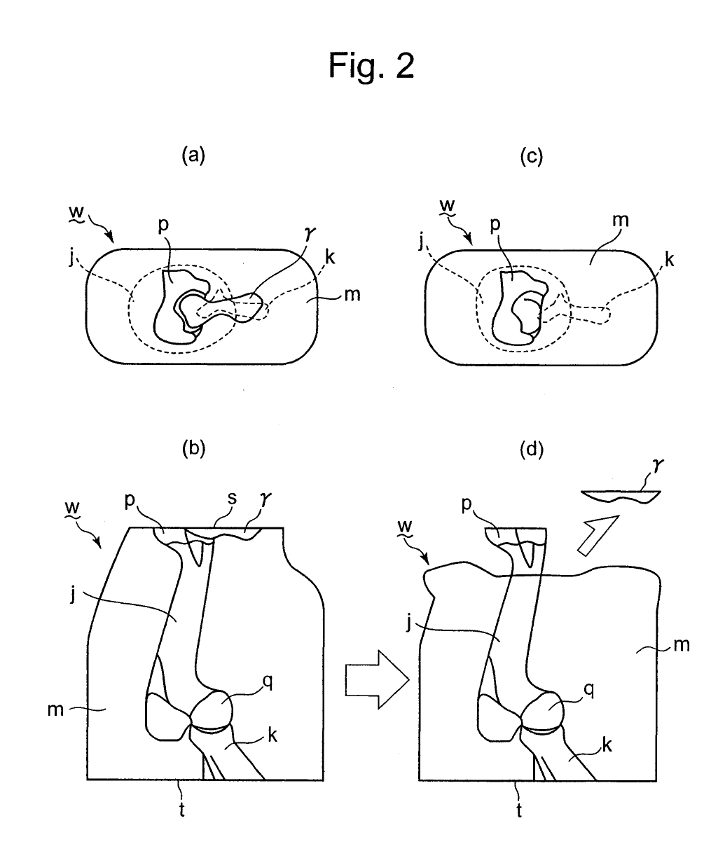

FIG. 2 shows a shape of a target work (an arm part) w for use in the present embodiment. In the drawing, s and t are cut surfaces cut by a cutting device, j is a humerus, r is a remaining part of a forearm bone, k is an upper part of a scapula, p is a joint part between the forearm bone and the humerus, q is a joint part between the humerus j and the scapula k, and m is a meat part attached to these bone parts. In FIG. 2, (a) and (b) show a state before the pretreatment by hand, and (c) and (d) show a state in which the remaining part r of the forearm bone is removed by hand to expose the joint part p between the humerus j and the forearm bone.

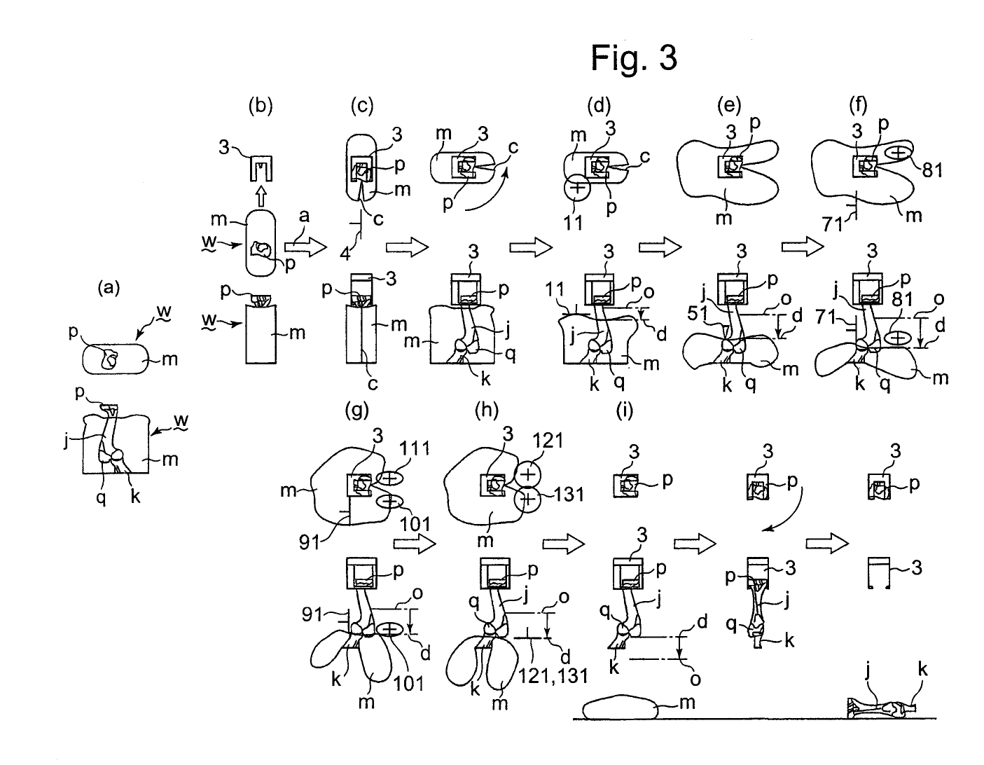

FIG. 3 shows treatment steps of the present embodiment. In this drawing, (a) shows a state after the pretreatment of the target work w by hand, that is, the same state as that shown in FIGS. 2(c) and (d), and (b) shows a step of hanging the target work w from a clamping unit 3 of a loader (not shown) of the apparatus according to the present embodiment. It is to be noted that a unit having a conventionally known structure is used in the clamping unit 3. In the present embodiment, a constricted part close to the joint part p between the humerus j and the forearm bone is clamped. Moreover, (c) shows a treatment at a first station of the apparatus according to the present embodiment. The meat part m of the target work w is provided with a cut c in a vertical direction by a round blade cutter 4 attached to a cutting device (not shown) in the vertical direction to expose the bone part. Subsequently, the clamping unit 3 is rotated by 90 degrees to direct the target work w in a conveyance direction a, and the work is conveyed to a second station.

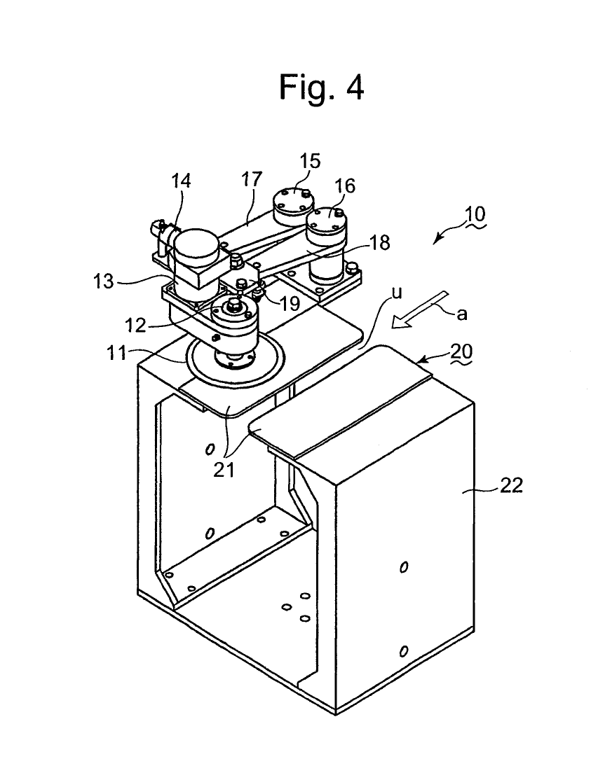

In the second station (d), the meat is peeled off from the upper part of the humerus down to a part of the humerus below the center thereof by a meat separator. Moreover, muscle of the center of the humerus is horizontally cut. FIG. 4 is a perspective view of a device 10 for use in the second station. In FIG. 4, reference numeral 20 is a meat separator having two separation plates 21 facing each other via a conveyance path of a meat block and including a driving device which vertically moves the separation plates 21, and 11 is a round blade cutter disposed at an upper portion of a housing 22 of the meat separator 20 in a horizontal direction. A rotary shaft 12 of the cutter is rotated by a driving motor 13. The driving motor 13 is connected to a piston of an air cylinder 14 disposed on an upper surface of the housing 22 via a bracket 19. The bracket 19 constitutes a parallelogram link mechanism together with rotary support points 15, 16 and links 17, 18. According to this constitution, the round blade cutter 11 can linearly reciprocate so as to come close to or away from the conveyance path of the target work w formed at a gap u between the separation plates 21 of the meat separator 20.

Moreover, the round blade cutter 11 is attached to the housing 22 to which the separation plates 21 are attached via the support points 15, 16 and the air cylinder 14, and vertically moves integrally with the housing 22 together with the separation plates 21.

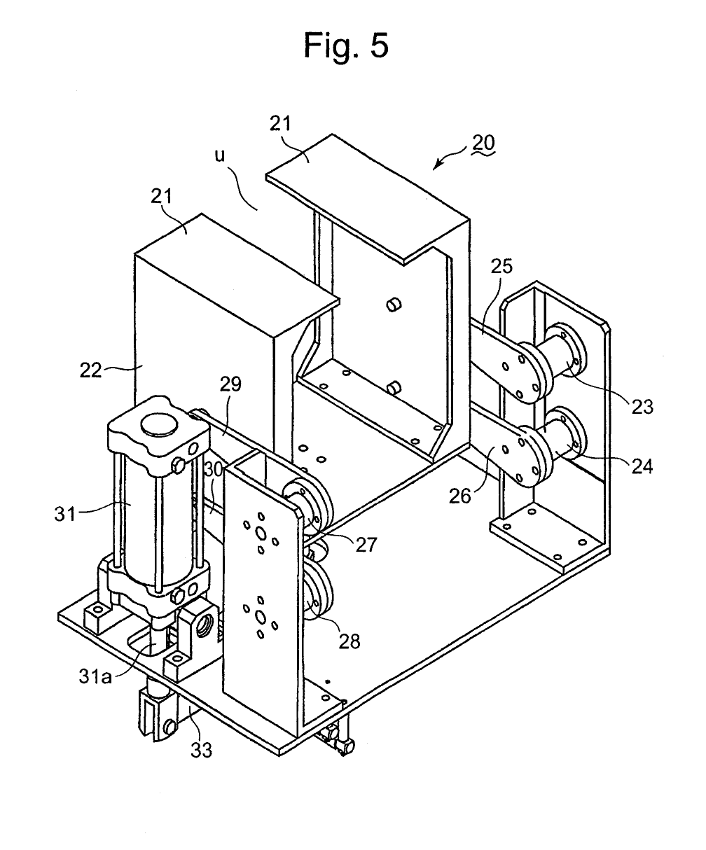

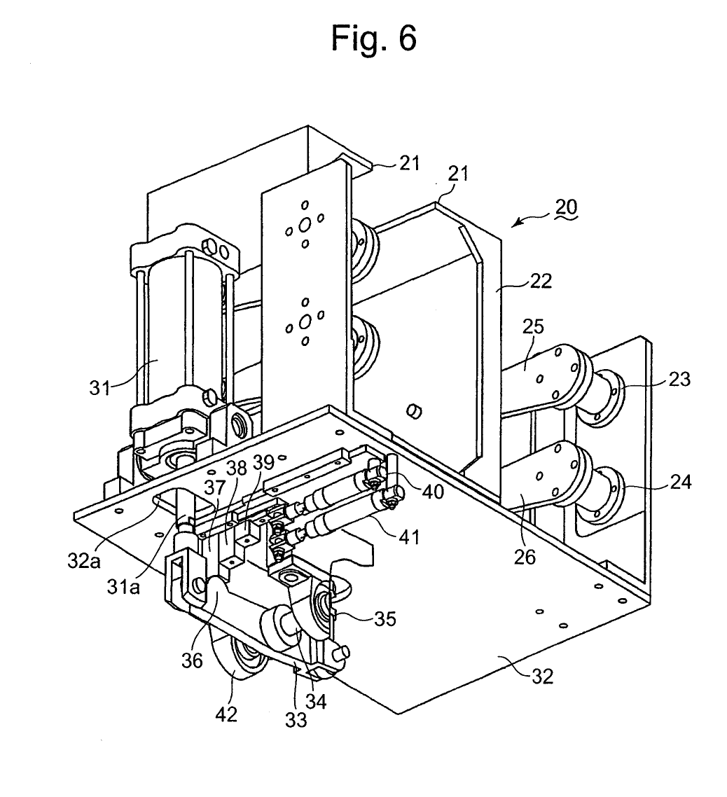

Next, the driving device which vertically reciprocates the separation plates 21 of the meat separator 20 will be described with reference to FIGS. 5 and 6. In FIGS. 5 and 6, the housing 22 to which a pair of separation plates 21 are integrally attached via the gap u forming the conveyance path of the target work w is supported so as to be vertically and linearly movable in the reciprocating manner by support points 23, 24 and links 25, 26 forming a parallelogram link mechanism at one side surface of the housing and support points 27, 28 and links 29, 30 similarly forming a parallelogram link mechanism at the other side surface.

Reference numeral 31 is an air cylinder which vertically drives the housing 22. As shown in FIG. 6, a piston 31a of the air cylinder 31 is extended down from a substrate 32 through a hole 32a disposed at the substrate 32 of the meat separator 20, and connected to one end of an arm 33 having a support point 34 fixed to a lower surface of the substrate 32. A rod 35 having the other end attached to a lower surface of the housing 22 is attached to the other end of the arm 33, and the arm 33 rotates in response to a vertical movement of the piston 31a to vertically move the housing 22.

At a connecting portion between the arm 33 and the support shaft 34, an engagement piece 36 extends from the arm 33, and the engagement piece 36 selectively abuts on any of upper surfaces of stoppers 37, 38 and 39 having different heights. Reference numerals 40 and 41 are air cylinders. When the air cylinders 40 and 41 are simultaneously or individually operated, any of the stoppers 37 to 39 can abut on the engagement piece 36 to adjust a stroke in three stages. At a forward end of the piston 31a of the cylinder 31, an original height before lowering the meat separator 20 is set. When the cylinder moves backwards, any of the stoppers 37 to 39 abuts on the engagement piece 26, so that the meat of the target works w can be peeled off at the different heights. Every time the work moves from the stopper 37 to 39, a lowering stroke increases. The piston is connected to the stoppers 37 to 39, and any of the stoppers 37 to 39 can selectively be arranged at a position on which the engagement piece 36 abuts. It is to be noted that reference numeral 42 is a support block which is attached to a back surface of the substrate 32 and which supports the support shaft 34 as the rotation center of the arm 33.

According to such a constitution, in a case where the air cylinder 31 is driven to vertically and linearly move the housing 22 so that the separation plates 21 forming the conveyance path of the target work w are lowered as much as a set length to peel off the meat part of the target work was much as the set length, any of the stoppers 37 to 39 is arranged at the position on which the engagement piece 36 abuts. In consequence, the housing 22 is lowered to a desired position from an original position set at a forward end position of the piston 31a of the cylinder 31.

Returning back to the second station of the first embodiment, at the second station, as shown in FIG. 3(d), when the device 10 of FIG. 4 is used, the target work w is inserted into the gap u between the separation plates 21, the meat separator 20 simultaneously lowers from an origin height o to a lowered position d, and the meat part of the target work w is peeled off to a part of the humerus below the center thereof from the upper part of the humerus j, while the target work w is moving through the gap u. Moreover, the round blade cutter 11 is allowed to come close to the target work w, and horizontally cuts the muscle of the center of the humerus.

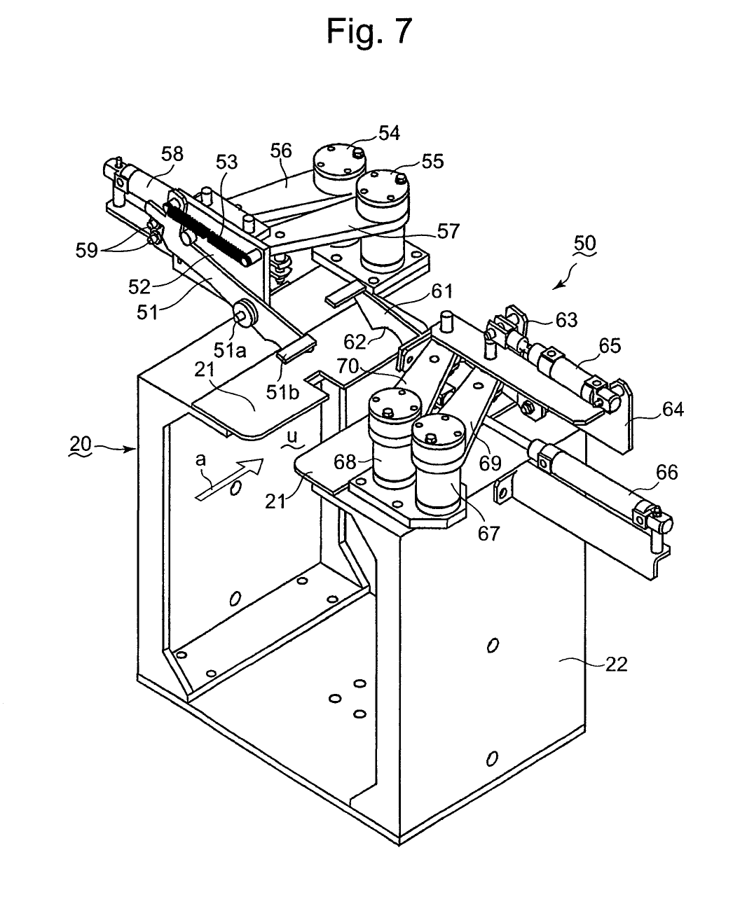

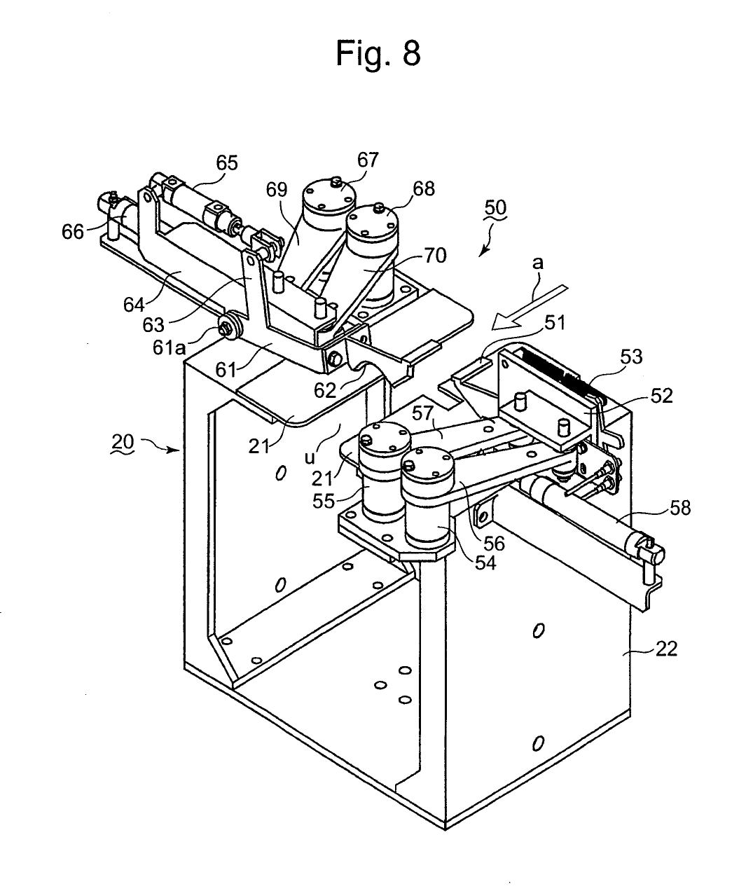

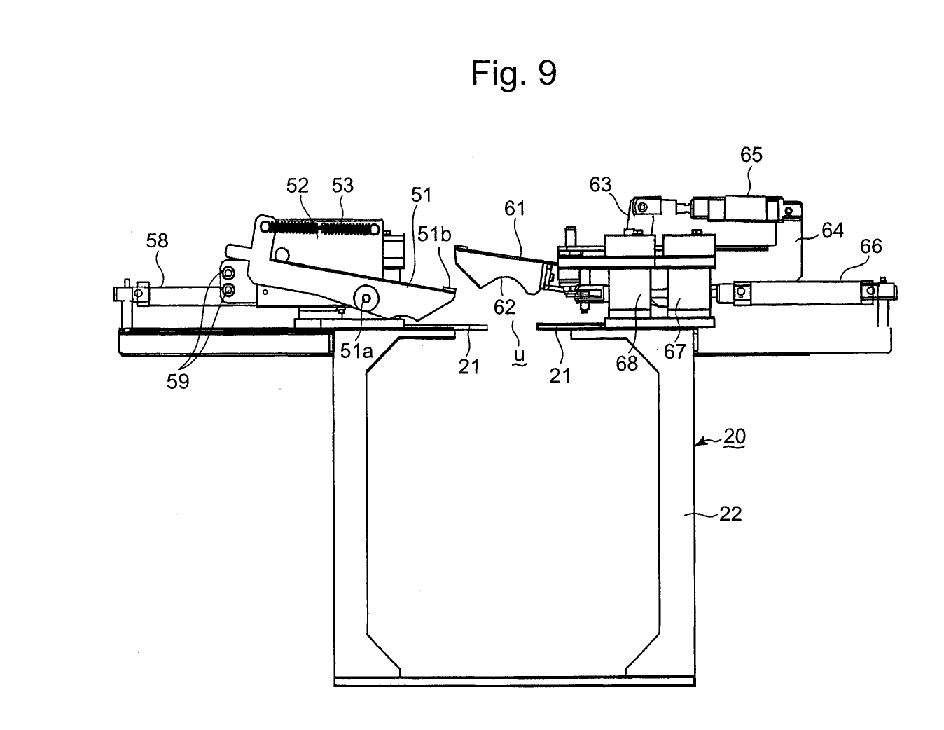

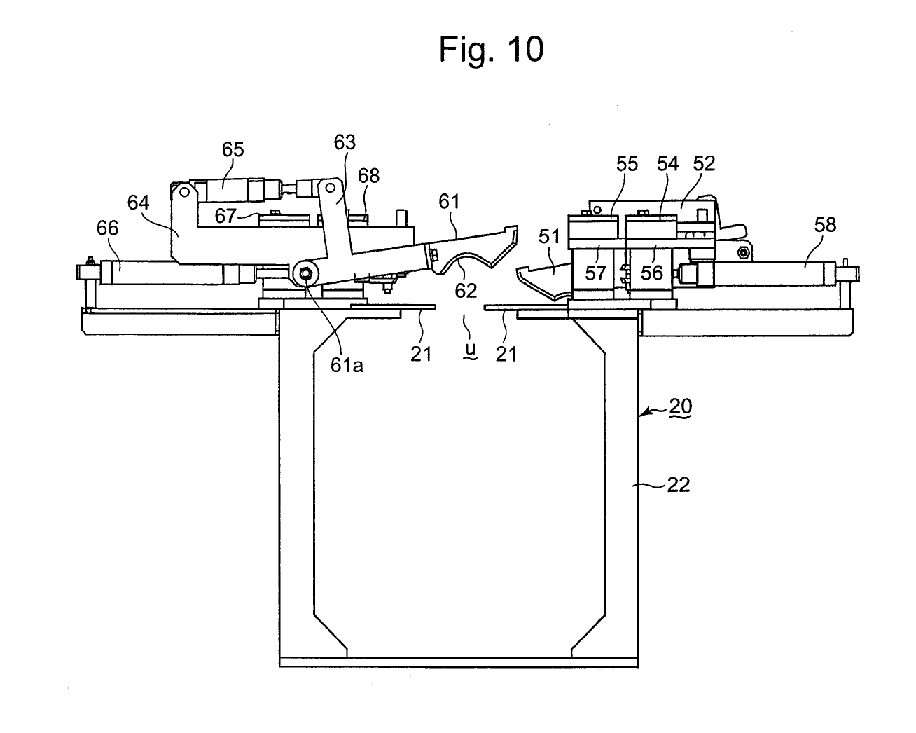

Next, a third station will be described. At the third station, as shown in FIG. 3(e), while the meat is further peeled off to the vicinity of the joint part q between the humerus j and the scapula k by the meat separator, a length from a reference position positioned at the upper part of the humerus j (a clamping position with the clamping unit 3 in the present embodiment) to an upper part of a projection of the joint part q between the humerus j and the scapula k is measured. The lowering stroke of the meat separator in the subsequent step is determined based on this measured value. A device 50 for use in the third station will be described with reference to FIGS. 7 to 10. In FIGS. 7 to 10, reference numeral 51 is a measurement plate. The measurement plate 51 is attached to a plate 52 so as to be rotatable centering on a rotary shaft 51a of the measurement plate. Similarly, a tip end art of the target work w positioned on the conveyance path is constantly urged downwards by a coil spring 53 having one end attached to the plate 52. The other end of each of links 56, 57 each having one end attached to rotation support points 54, 55 is attached to the plate 52 to form a parallelogram link mechanism. Moreover, the plate 52 is attached to a piston of an air cylinder 58. According to this constitution, the measurement plate 51 can linearly reciprocate so as to come close to or away from the target work w at the conveyance path which is the gap u formed between a pair of separation plates 21 facing each other.

On the other hand, reference numeral 61 is a peeling plate having a cutter 62 at a tip end thereof. The peeling plate 61 is attached to a bracket 64 so as to be rotatable centering on a rotation support shaft 61a, and an arm piece 63 which protrudes from the peeling plate 61 is connected to a piston of an air cylinder 65 attached to the bracket 64. In consequence, the tip end blade 62 of the peeling plate 61 can vertically be moved by the air cylinder 65 above the gap u constituting the conveyance path of the target work w.

Moreover, the bracket 64 is connected to a piston of an air cylinder 66 installed at the housing 22. Moreover, the other end of each of links 69 and 70 each having one end connected to rotation support points 67, 68 is connected to the bracket 64 to form a parallelogram link mechanism. Therefore, according to this constitution, the peeling plate 61 can linearly reciprocate so as to come close to or away from the conveyance path of the target work w.

It is to be noted that, since both of the measurement plate 51 and the peeling plate 61 are installed on the housing 22 constituting the meat separator 20, the plates vertically move together with the vertical movement of the meat separator 20.

In a device 50 constituted in this manner, when the target work w enters the conveyance path formed at the gap u between the separation plates 21 from a conveyance direction a, the meat separator 20 starts lowering, and the separation plates 21 lower. Therefore, the meat attached to the humerus j is peeled off from the original height o to the lowered position d in the vicinity of the joint part q between the humerus j and the scapula k.

Next, the measurement plate 51 comes close to the conveyance path of the target work w to ride on the joint part q between the humerus j and the scapula k from behind the humerus j. The measurement plate 51 simultaneously lowers together with the peeled meat, touches the upper surface of the joint part q between the humerus j and the scapula k, and stops there.

Subsequently, when the peeling plate 61 comes close to the conveyance path of the target work w and the peeling plate 61 comes in contact with a rear part of the humerus j of the target work w to peel off the meat of the upper surface of the joint part q between the humerus j and the scapula k behind the humerus by a lowering movement of the cutter 62.

Subsequently, the meat separator 20 starts lowering, and the separation plates 21 lower. Therefore, the meat attached to the humerus j is peeled off from the original height o to the lowered position d in the vicinity of the joint part q between the humerus j and the scapula k by the cutter 62 of the peeling plate 61. The measurement plate 51 simultaneously lowers together with the peeled meat, touches the upper surface of the joint part q between the humerus j and the scapula k, and stops there.

It is to be noted that, since angle sensors 59 for detecting a tilt angle of the measurement plate 51 are attached to the plate 52, the lowered position of a contact plate 51b attached to the tip end of the measurement plate 51 can be measured by these sensors 59. In consequence, since the length from the reference position (the clamping position with the clamping unit 3) of the target work w to the joint part q between the humerus j and the scapula is detected, the lowering stroke (the present embodiment has three alternatives of large, medium and small strokes) of the meat separator in the subsequent step is selected based on this measured value.

Subsequently, the target work w is moved to a fourth station. At the fourth station, as shown in FIG. 3(f), the muscle around the joint part q between the humerus j and the scapula k is cut by a round blade cutter and the meat is further peeled off by a meat separator.

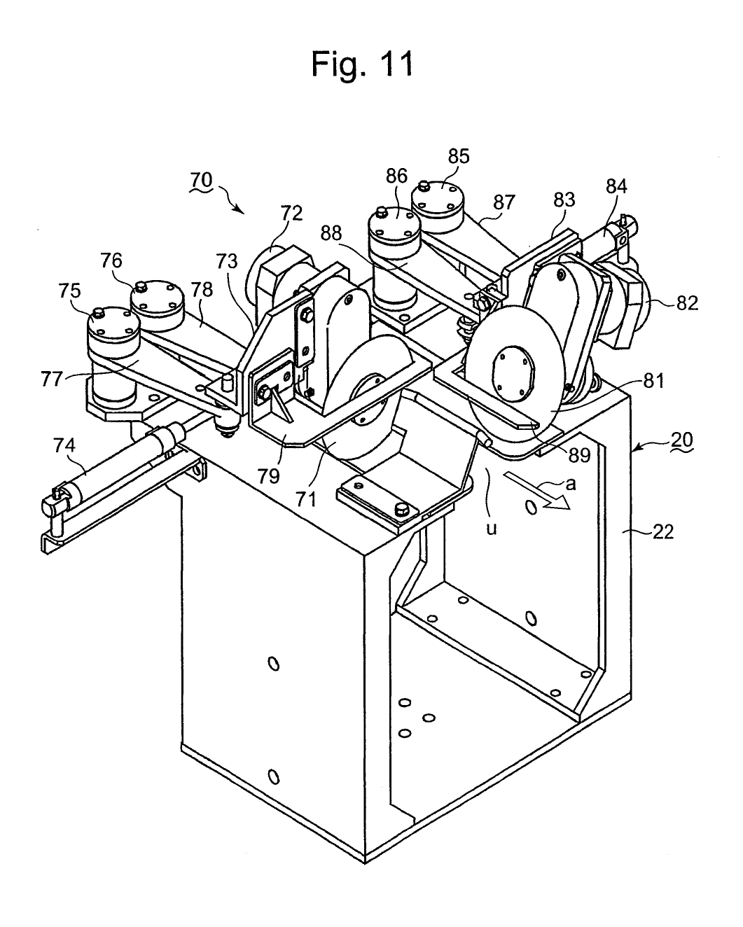

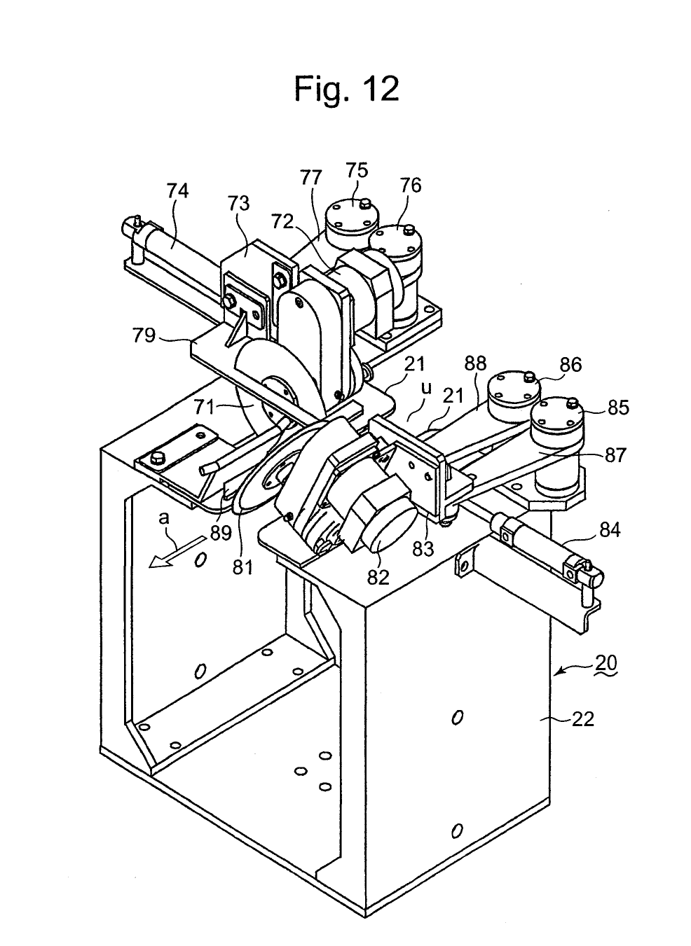

FIGS. 11 and 12 are both perspective views of a device for use in the fourth station. In FIGS. 11 and 12, reference numeral 71 is a round blade cutter which cuts the muscle attached to a part behind the joint part q of the target work w. The cutter is arranged in a vertical direction crossing the conveyance direction of the target work w at right angles. Reference numeral 72 is a motor which drives the rotary shaft of the round blade cutter 71, and the motor is attached to a bracket plate 73. The bracket plate 73 is connected to a piston of an air cylinder 74 installed at the housing 22 of the meat separator 20. Moreover, the other end of each of links 77, 78 each having one end attached to rotation support points 75, 76 is attached to the bracket plate 73 to form a parallelogram link mechanism. According to this constitution, the round blade cutter 71 can linearly reciprocate so as to come close to or away from the conveyance path of the target work w. It is to be noted that reference numeral 79 is a safety plate which covers the round blade cutter 71, and the plate is attached to the bracket plate 73.

Reference numeral 81 is a round blade cutter for cutting muscle. The cutter is arranged in parallel with the conveyance path of the target work w, and an upper portion of the cutter is obliquely arranged in such a direction as to come away from the conveyance path. The cutter is rotated by a driving motor 82 attached to a bracket plate 83. The bracket plate 83 is connected to a piston of an air cylinder 84 installed at the housing 22. Moreover, the other end of each of links 87 and 88 each having one end attached to rotation support points 85, 86 is attached to the bracket plate 83 to constitute a parallelogram link mechanism. According to this constitution, the round blade cutter 81 can linearly reciprocate so as to come close to or away from the conveyance path of the target work w. It is to be noted that reference numeral 89 is a safety plate which covers the round blade cutter 71, and the plate is attached to the bracket plate 83.

It is to be noted that, since the round blade cutters 71 and 81 are both installed on the housing 22 constituting the meat separator 20, the cutters vertically move together with the vertical movement of the meat separator 20.

In the fourth station, as shown in FIG. 3(f), when the target work w enters the conveyance path formed at the gap u between the separation plates 21, the housing 22 on which the round blade cutters 71 and 81 are fixed lowers from the original height o of the housing as much as a stroke (to the position d) determined based on the measured value obtained in the third station. Therefore, the meat around the joint part q is peeled off as much as the lowering stroke. The round blade cutters 71 and 81 are simultaneously pushed out to the conveyance path, the round blade cutter 71 cuts the muscle attached to a periphery of a rear part of the joint part q, and the round blade cutter 81 cuts the muscle attached to a side surface of the joint part q.

Subsequently, the target work w is conveyed to a fifth station. In the fifth station, as shown in FIG. 3(g), the muscle around a lower part of the joint part q between the humerus j and the scapula k is further cut with three round blade cutters, and the meat is further peeled off by the meat separator.

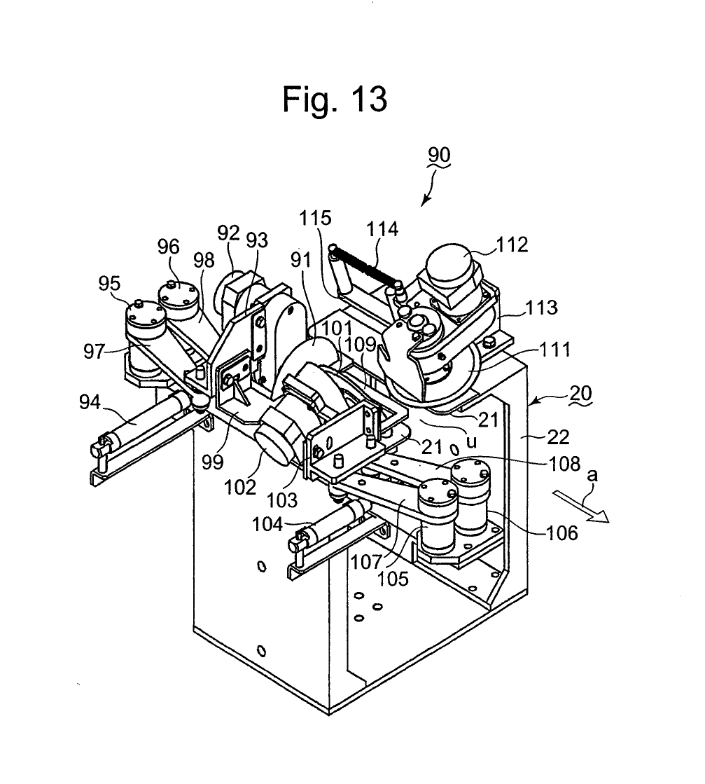

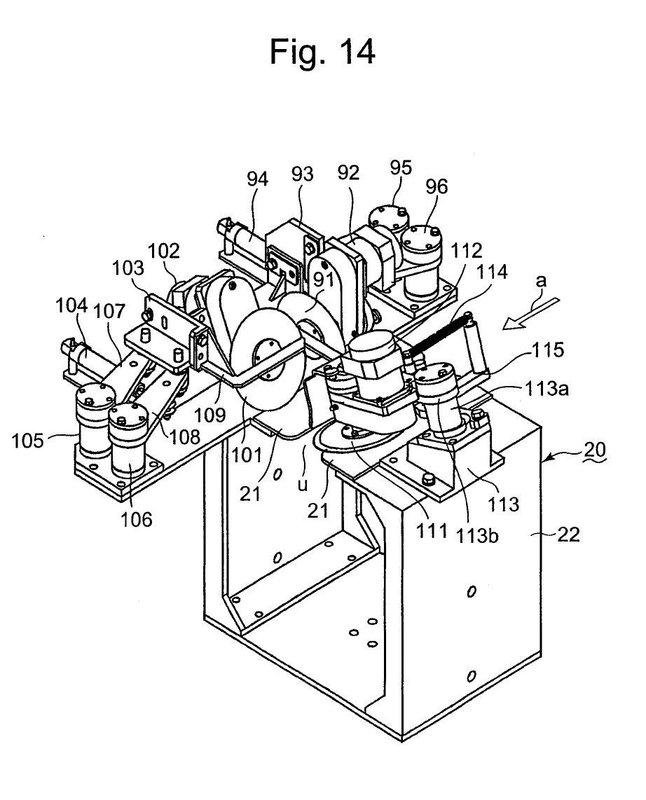

FIGS. 13 and 14 are perspective views of a device for use in the fifth station as obliquely viewed from above on the left and right sides. In FIGS. 13 and 14, reference numeral 91 is a round blade cutter which cuts the muscle attached to a lower part behind the joint part q of the target work w. The cutter is arranged in a vertical direction crossing the conveyance direction of the target work w at right angles. Reference numeral 92 is a motor which drives and rotates the round blade cutter 91, and the motor is attached to a bracket plate 93. The bracket plate 93 is connected to a piston of an air cylinder 94 installed at the housing 22 of the meat separator 20. Moreover, the other end of each of links 97, 98 each having one end attached to rotation support points 95, 96 is attached to the bracket plate 93 to form a parallelogram link mechanism. According to this constitution, the round blade cutter 91 can linearly reciprocate so as to come close to or away from the conveyance path of the target work w. It is to be noted that reference numeral 99 is a safety plate which covers the round blade cutter 91, and the plate is attached to the bracket plate 93.

Reference numeral 101 is a round blade cutter for cutting muscle. The cutter is arranged in parallel with the conveyance path of the target work w, and an upper portion of the cutter is obliquely arranged in such a direction as to come away from the conveyance path. The cutter is rotated by a driving motor 102 attached to a bracket plate 103. The bracket plate 103 is connected to a piston of an air cylinder 104 installed at the housing 22. Moreover, the other end of each of links 107 and 108 each having one end attached to rotation support points 105, 106 is attached to the bracket plate 103 to constitute a parallelogram link mechanism. According to this constitution, the round blade cutter 101 can linearly reciprocate so as to come close to or away from the conveyance path of the target work w. It is to be noted that reference numeral 109 is a safety plate which covers the round blade cutter 101, and the plate is attached to the bracket plate 103.

Reference numeral 111 is a round blade cutter disposed on such a side as to face the conveyance path of the target work w with respect to the round blade cutter 101. The cutter is fixed and rotated by a bracket 113b which fixes a driving motor 112 via a swing shaft 113a attached to a bracket 113 mounted on and fixed to the upper surface of the housing 22. Reference numeral 114 is a coil spring attached to an arm 115 having one end fixed to the bracket 113, and the other end of the spring is attached to the bracket 113b. When the swing shaft 113a swings, the round blade cutter 111 is urged with such a force as to press the joint part q from below.

According to a device 90 constituted in this manner, in the fifth station, when the target work w enters the conveyance path formed at the gap u between the separation plates 21, as shown in FIG. 3(g), the housing 22 on which the round blade cutters 91, 101 and 111 are mounted and fixed lowers from the original height o to the lowered position d set based on the length of the humerus j measured in the third station. In consequence, the meat around the joint part q is peeled off. Furthermore, the round blade cutters 91 and 101 are pushed out to the conveyance path, the round blade cutter 91 cuts the muscle attached to a part around a lower rear part of the joint part q, and the round blade cutter 101 cuts the muscle attached to a lower side surface of the joint part q. Moreover, the round blade cutter 111 cuts the lower side surface of the joint part q on such a side as to face the round blade cutter 101. In the fifth station, the peeling of the meat attached to the joint part q is completed.

Subsequently, the target work w is conveyed to a sixth station. In the sixth station, as shown in FIG. 3(h), the muscle attached to a periphery of the scapula k is cut by two round blade cutters, and the meat attached to the scapula k is peeled off by a meat separator.

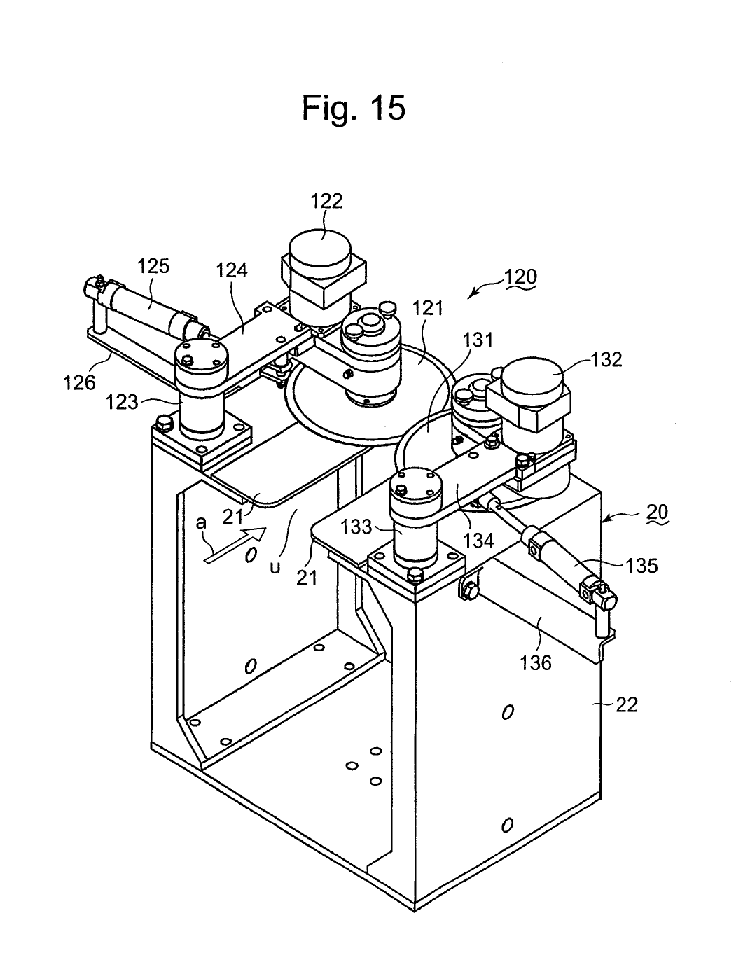

FIG. 15 is a perspective view of a device for use in the sixth station as obliquely viewed from above. In FIG. 15, reference numeral 121 is a round blade cutter for cutting the muscle attached to the surface of the scapula k. The cutter is arranged in a horizontal direction, and a rotation driving motor 122 of the cutter is rotatably connected to a support shaft 123 via a bracket 124. Reference numeral 125 is an air cylinder supported by an arm 126 attached to the upper surface of the housing 22. When a piston of the air cylinder is connected to the bracket 124, the round blade cutter 121 can reciprocate in such a direction as to come close to or away from the conveyance path of the target work w formed at the gap u between the separation plates 21.

Reference numeral 131 is a round blade cutter arranged in a horizontal direction at such a position as to face the round blade cutter 121 via the conveyance path. A rotation driving motor 132 of the cutter is rotatably attached to a support shaft 133 via a bracket 134. Reference numeral 135 is an air cylinder supported by an arm 136 attached to the upper surface of the housing 22. When a piston of the air cylinder is connected to the bracket 134, the round blade cutter 131 can reciprocate in such a direction as to come close to or away from the conveyance path of the target work w formed at the gap u between the separation plates 21.

According to a device 120 constituted in this manner, in the sixth station, when the target work w enters the conveyance path formed at the gap u between the separation plates 21, as shown in FIG. 3(h), the housing 22 on which the round blade cutters 121 and 131 are mounted and fixed lowers from the original height o to the lowered position d set based on the length of the humerus j measured in the third station. Therefore, the meat around the scapula k is peeled off. Moreover, the round blade cutters 121 and 131 are simultaneously pushed out to the conveyance path to cut the muscle attached to opposite sides of the surface of the scapula k of the target work w.

Subsequently, the target work w moves to a seventh station. In the seventh station, the peeling of the meat attached to the scapula k is completed by the meat separator.

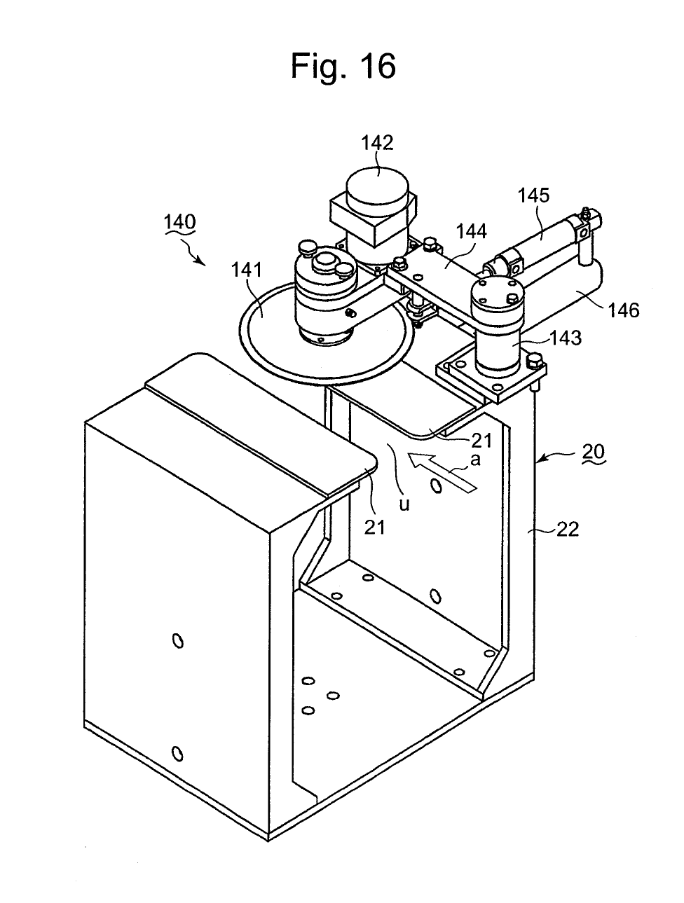

FIG. 16 is a perspective view of a device for use in the seventh station. In FIG. 16, reference numeral 141 is a round blade cutter arranged in a horizontal direction. The round blade cutter is preliminarily installed at a limit position so as to cut the scapula k at the limit position, in a case where the scapula is longer than a set limit length. A rotation driving motor 142 of the round blade cutter 141 is rotatably connected to a support shaft 143 attached to the upper surface of the housing 22 via a bracket 144. Reference numeral 145 is an air cylinder supported by an arm 146 attached to the upper surface of the housing 22. Since a piston of the air cylinder is connected to the bracket 144, the round blade cutter 141 can reciprocate in such a direction as to come close to or away from the conveyance path of the target work w formed at the gap u between the separation plates 21.

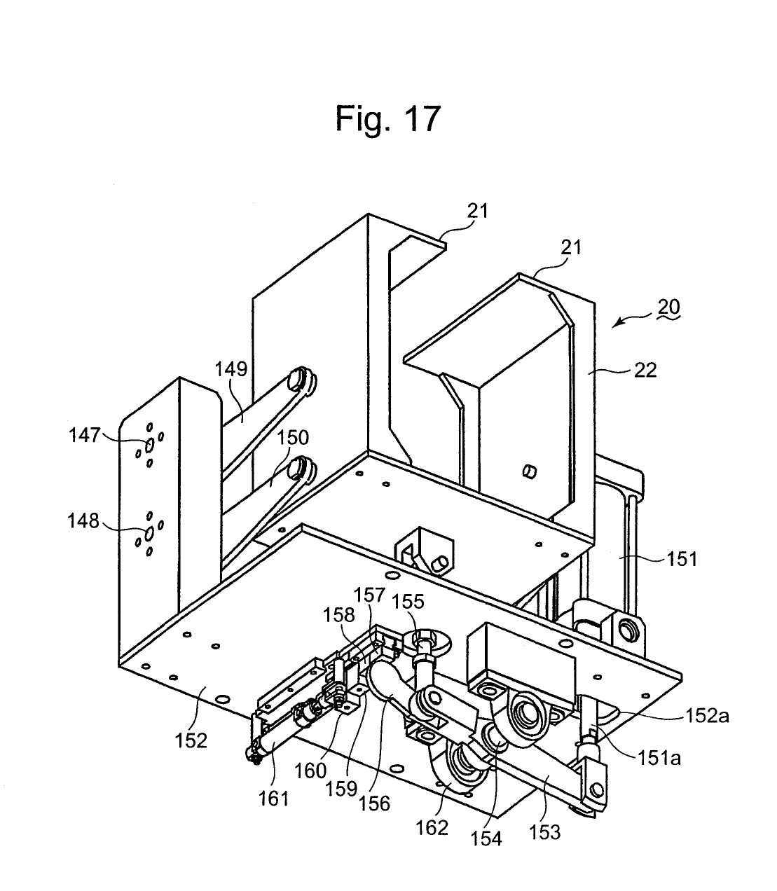

According to a device 140 constituted in this manner, in the seventh station, unlike the other stations, the separation plates 21 are inserted at a height d shown in FIG. 3(h). Since the meat part m needs to be peeled from the height, the original height o needs to be varied. A mechanism which vertically moves the housing 22 of the device of FIG. 16 in order to vary the height is shown in FIG. 17.

In FIG. 17, reference numeral 151 is an air cylinder which vertically drives the housing 22, and a piston 151a of the air cylinder 151 is extended below a substrate 152 through a hole 152a disposed at the substrate 152 of the meat separator 20, and connected to one end of an arm 153 having a support shaft 154 fixed to a lower surface of the substrate 152. A rod 155 having the other end attached to the lower surface of the housing 22 is attached to the other end of the arm 153. The arm 153 rotates in response to a vertical movement of the piston 151a to vertically move the housing 22.

At a connecting portion between the arm 153 and the support shaft 154, an engagement piece 156 extends from the arm 153, and the engagement piece 156 selectively abuts on any of upper surfaces of stoppers 157, 158, 159 and 160 having different heights.

Reference numeral 161 is an air cylinder. A piston of the air cylinder is connected to stoppers 157 to 160, and any of the stoppers 157 to 160 can selectively be arranged at a position on which the engagement piece 156 abuts. It is to be noted that 162 is a support block which is attached to a back surface of the substrate 152 and which supports the support shaft 154 as a rotation center of the arm 153. It is to be noted that a height of the housing can be changed in four stages of the stoppers 157 to 160 by the air cylinder 161, but three stages of the stoppers 158 to 160 are actually used. Every time the height is changed from the stoppers 157 to 160, the original height o lowers. A backward end of the meat separator 20 is fixed at a stroke end.

According to such a constitution, when the target work w enters the conveyance path formed at the gap u between the separation plates 21 and the scapula k is cut to an allowable length as shown in FIG. 3(i), the round blade cutter 141 does not operate, the only meat separator 20 operates to peel off the meat attached to the scapula k, and the meet is completely separated from the bone part to drop down. If the scapula k is longer than an allowable length, the round blade cutter 141 is pushed out to the conveyance path of the target work w, and an extra part over the allowable length is cut.

In the seventh station, as shown in FIG. 3(i), the original height o of the meat separator is set to a lower position, and the meat separator once moves up from the original height o to a raised position d set based on the length of the humerus j measured in the third station. When the meat separator lowers from the raised position, the meat attached to a periphery of the scapula k is completely peeled off and allowed to drop down.

Subsequently, after the only remaining bone part is conveyed with the loader, the clamping unit 3 is rotated by 90 degrees and directed to a discharge side, and the bone part is removed.

According to such a first embodiment, slight pretreatment by hand is involved, but the substantially completely automated deboning treatment of the target work can be realized. In consequence, reduction of a treatment time and improvement of a treatment efficiency can be achieved.

Moreover, while the target work w hung from the loader is conveyed at a substantially constant height, the work can be subjected to all the steps of the first to seventh stations without discontinuing the conveyance halfway. Therefore, large reduction of the treatment time and rapid improvement of the treatment efficiency can be achieved.

Furthermore, since the treatment step is finely divided into the first to seventh stations and the cutting of the muscle bonded to the bone and the peeling of the meat are finely performed in the stations, unlike Prior Art 1, the humerus j of the target work w does not have to be separated from the scapula k, and the meat can completely be separated without leaving any extra meat at the bone.

In addition, halfway in the treatment steps, the reference position is set to the constricted part of the humerus j clamped with the loader, the length from this reference position to the upper part of the joint part between the humerus and the scapula is measured, and a lowering length of the meat separator in each station is set based on the measured value. Therefore, even if the arm part of the treatment target has different length and size, a cutting position of the round blade cutter and a reference height and the lowering length of the meat separator can be changed so as to cope with the difference according to circumstances.

According to the present invention, in a bone removing treatment of a meat block of a humerus part including a remaining part of a scapula of a shoulder part in the half block of back split meat, a slight pretreatment by hand is required, but a substantially completely automated deboning treatment can be realized. Therefore, reduction of a treatment time and improvement of a treatment efficiency can be achieved. Moreover, the treatment is divided into first to fifth steps. In each stage of the treatment step, while muscle bonded to a bone is cut, the meat is finely peeled off in a stepwise manner. Therefore, the humerus of a target work does not have to be separated from the scapula, and the meat can clearly be separated without leaving any extra meat at the bone.

Moreover, halfway in the treatment steps, a reference position is set to an upper part of the humerus, a length from this reference position to a joint part between the humerus and the scapula is measured, and a lowering stroke of a meat separator in each station is set based on the measured value. Therefore, even if an arm part of a treatment target has different length and size, a cutting position of a round blade cutter and a reference height and the lowering stroke of the meat separator can be changed so as to cope with the difference according to circumstances.

Further preferably, the meat block hung from a loader is conveyed at a substantially constant height, and a target work can be subjected to all the steps without discontinuing the conveyance halfway and without deviation the target work from a conveyance path of the work. Therefore, large reduction of the treatment time and rapid improvement of the treatment efficiency can usefully be achieved.

What is claimed is:

1. A method of deboning a meat block which is cut along a joint part between a forearm bone and a humerus and at an upper part of a scapula, including the humerus and a part of the scapula while hanging and conveying the meat block with a loader, the method comprising:
a first step of perpendicularly cutting the meat block to expose bone parts;
a second step of peeling off the meat from an upper part of the humerus to a part of the humerus below the center thereof with a meat separator and horizontally cutting muscle of the center part of the humerus;
a third step of further peeling off the meat down to a joint part between the humerus and the scapula with a meat separator and measuring a length from a reference position positioned at the upper part of the humerus to the joint part between the humerus and the scapula to determine a lowering stroke of the meat separator in the subsequent step or steps based on a value of the length thus measured;
a fourth step of peeling off, in a stepwise manner, the meat around the joint part with a meat separator while cutting the muscle around the joint part between the humerus and the scapula; and
a fifth step of cutting muscle around the scapula and peeling off the meat around the scapula with a meat separator.

2. The method of deboning the meat block according to claim 1, wherein in a pretreatment, a remaining part of the forearm bone is removed to expose a bone of the joint part of the humerus.

3. The method of deboning the meat block according to claim 1, wherein a constricted part of the joint part between the forearm bone and the humerus is clamped and hung with a clamping device of the loader, the reference position is a clamping position of the clamping device, and a length from the reference position to an upper surface of a projection of the joint part between the humerus and the scapula is measured.

4. An apparatus for deboning a meat block which is cut along a joint part between a forearm bone and a humerus and at an upper part of a scapula, including the humerus and a part of the scapula while hanging and conveying the meat block with a loader, wherein the loader is configured to pass through a plurality of stations and perform deboning treatment while the loader hangs the meat block to convey the meat block in a horizontal direction, at least a part of the stations includes a round blade cutter to cut muscle arranged along a conveyance path of the meat block, a meat separator which separates meat of the meat block from a bone, and a measurement device which measures a length from a reference position positioned at an upper part of the humerus to a joint part between the humerus and the scapula, and a lowering stroke from an original height of the meat separator arranged at each of the stations is determined based on the measured value.

5. The apparatus for deboning the meat block according to claim 4, wherein the meat separator has two separation surfaces which face each other along the conveyance path of the meat block, and includes a driving device which vertically moves the separation surfaces.

6. The apparatus for deboning the meat block according to claim 4, wherein the plurality of stations are substantially installed at an equal height level, and the loader hangs and conveys the meat block at a substantially constant height over all deboning steps.
